(19) United States
(12) Patent Application Publication
(10) Pub. No.: US 2019/0141962 A1
(43) Pub. Date: May 16, 2019

(54) FUME BOARD

(71) Applicants: Edgar Reeves Jones, Jackson, MS (US); Nicholas Dadant, Hamilton, IL (US)

(72) Inventors: Edgar Reeves Jones, Jackson, MS (US); Nicholas Dadant, Hamilton, IL (US)

(21) Appl. No.: 15/998,439

(22) Filed: Aug. 15, 2018

Related U.S. Application Data
(60) Provisional application No. 62/545,547, filed on Aug. 15, 2017.

(51) Int. Cl. A01K 47/06; A01K 55/00; A01K 51/00; A01K 59/00

(52) U.S. Cl. CPC A01K 47/06; A01K 55/00; A01M 2200/012; A01K 59/00; A01K 51/00

(57) ABSTRACT

An improved fume board and methods related to the same are provided. An improved fume board employing a motorized fan to quickly and uniformly deliver repellant throughout a honey super to result in near complete clearance of bees from the honey super in an efficient manner without significant disruption to the bee hive. The improved fume board box has a top entry portal and fan-blower connecting mechanism which allow for the incorporation of various small, battery powered fan-blowers currently available on the market. The small fan-blower generates a steady, low-volume air-flow that mixes air with bee repellant, which is then evenly distributed down into the honey super. The low-volume air-flow significantly increases repellant dispersal without agitating or intoxicating the bees, and without the additional danger of injuring bees. By effectively controlling the dispersal of repellant and preserving the environment inside the honey super, beekeepers can quickly and efficiently evacuate bees from supers prior to honey extraction.

### CROSS-REFERENCE TO RELATED APPLICATIONS

This application is claims priority to U.S. Provisional Application Ser. No. 62/545,547, filed Aug. 15, 2017, the disclosure of which is incorporated by reference in its entirety.

### FIELD OF THE INVENTION

The presently disclosed subject matter relates to honey bee hives and honey production, and more particularly to a method and device for removing worker bees from hive supers prior to extraction of honey.

### BACKGROUND OF THE INVENTION

Honey production in the United States exceeded 156 million pounds in 2015. (Mar. 22, 2016, National Agricultural Statistics Service (NASS), Agricultural Statistics Board, United States Department of Agriculture (USDA) ISSN: 1949-1492). Honey production requires extraction of raw honey from wax-capped foundations held in “supers,” which rest on top of a hive's brood box. A beekeeper must remove all the bees from the honey-filled frames before transferring the frames to a location for extraction. Consequently, the time and effort required to remove bees from supers prior to honey extraction impacts directly on the profitability of honey production.

There are generally three ways of removing bees from hive supers: 1) manually; 2) with an escape device; and 3) with a chemical repellant applied to a fume board. Manual removal, e.g. use of high-powered gasoline blowers, tends to agitate bees, often causing the bees to exit the hive. Manual removal of bees is also a time-consuming process not suitable for commercial beekeepers with hundreds of hives. Hive escape devices, such as escape boards, allow bees to pass down from the honey super into the brood box, but prevents the bees from returning back to the honey super. One escape board is required every 24 hours per super resulting in a large number of escape boards and amount of time required to harvest honey from multiple hives. Finally, fume boards sprayed with a chemical bee repellant are by far the most popular method for removing bees from supers prior to honey extraction and in various forms have been used for many years.

For instance, a 1962 patent describes in very general terms various means for utilizing chemical repellants like propionic or acetic acid to remove bees from honey supers. (see U.S. Pat. No. 3,122,473, incorporated herein by reference.) The inventor's descriptions of the various methods for bee repellant dispersal include placing a repellant soaked cloth pad on a piece of composition board and allowing it to volatize near an open super; using natural air currents or enhanced circulation to circulate repellant throughout the supers; or alternatively, to place the repellant soaked material “in an enclosure having an opening through which air is forced into the enclosure, and an exit opening which is adapted for attaching to a super.”

In 1969, a method was patented to introduce into a bee hive effective amounts of nontoxic organic acid or base for repelling bees from honey supers. (see U.S. Pat. No. 3,122,473, incorporated herein by reference.) The inventor describes a wooden hive cover (body member) with an absorbent pad affixed under the cover with an adhesive. The pad is soaked with an irritant compound, which slowly vaporizes into the super, causing the bees to evacuate the super. The claimed devise described above closely resembles what is today generally known as a “traditional fume board.”

A traditional fume board refers to a wood-frame box that sits on top of a hive super with a thin metal top and an open bottom. The top is lined with a soft foam or absorbent fabric such as felt or burlap, which the beekeeper sprays with a non-toxic bee repellant. Traditional fume boards do not have moving parts and instead use the heat of the sun to warm the metal top, which in turn heats and volatizes the repellant, thus speeding up dispersal of the repellant throughout the super. Traditional fume boards do not work well on cool or cloudy days because they rely on the sun's heat to help disperse the repellant. Even on sunny days, it is not unusual for traditional fume boards take from 10 to 30 minutes to move bees from a super.

A “breeze board” (or “breeze box”) is a variation of the traditional fume board. A breeze board uses the wind to accelerate dispersal of bee repellant down into the super, thus reducing the time required to move bees from a super. Unlike a traditional fume board, which has absorbent fabric attached to the underside of its metal top, a breeze board has thin, porous fabric stretched across its open bottom. Instead of a flat top, a breeze board's top has a relatively large hole into which a short metal or plastic elbow pipe is fitted. Wind enters the pipe and travels down into the breeze box, where it passes through the repellant saturated porous fabric, dispersing the repellant fumes down into the super. Breeze boards can be heavy and cumbersome to move from hive to hive, and only work on windy days. Additionally, it is difficult to control the volume of wind entering a breeze board and consequently, if the wind volume is too high, too much of the chemical repellent is forced into the super, causing the bees to become intoxicated or flee the hive in a swarm.

Thus, there exists a need for an improved fume board design that overcomes the deficiencies of the prior art of being time, cost and labor intensive, while not harming or agitating the bee population within the hive during the evacuation of bees from honey supers.

### SUMMARY OF THE INVENTION

According to the present invention, there is provided an improved fume board design that provides an easily controllable, rapid method for increasing dispersal of bee repellant throughout a super without agitating or intoxicating the bees. An air intake portal, a fan-blower connecting mechanism, and an air disbursement system allows the improved fume board to operate with various small, battery powered fan-blowers currently available on the market. The small fan-blower generates a steady, low-volume air-flow that mixes with the repellant and is then evenly distributed down into the super. The low-volume air-flow significantly increases repellant dispersal without agitating or intoxicating the bees, and without the additional danger of injuring bees with high-volume air-flow similar to that discharged from gasoline powered bee blowers. By effectively controlling dispersal of repellant and preserving the honey super environment in a bee hive, beekeepers can quickly and efficiently remove bees from supers prior to honey extraction.

### BRIEF DESCRIPTION OF THE DRAWINGS

Further advantages of the invention will become apparent by reference to the detailed description of an embodiment of the invention when considered in conjunction with the drawings which form a portion of the disclosure and wherein:

FIG. 1 is an exploded top diagonal view of the preferred embodiment of the improved fume board with detachable air-diverter

FIG. 2 is a side view of the fan-blower attached to the detachable air-diverter.

FIG. 3 is an exploded view of the fan-blower and fan-blower exhaust conduit.

FIG. 4 is a top diagonal view of the preferred shape of the fume board box.

FIG. 5 is a bottom view of the fume board box with centered air-intake portal.

FIGS. 6A-6C depict the preferred visual dimensions of the fume board box with centered air-intake portal. Individually, FIG. 6A is a front view of the fume board box. FIG. 6B is a top view of the fume board fox. FIG. 6C is a side view of the fume board fox.

FIG. 7 is a cross sectional view of the improved fume board box with detachable air-diverter.

FIG. 8 is the improved fume board invention positioned on top of a honey super.

### DETAILED DESCRIPTION OF THE INVENTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiment, is provided primarily for clearness of understanding and no unnecessary limitations are to be understood therefrom. Further, while the terms used herein are believed to be well-understood by one of ordinary skill in the art, definitions are set forth to facilitate explanation of the presently-disclosed subject matter. The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed above.

The instant invention improves upon repellant fume boards by employing a motorized fan with a dispersing apparatus to quickly and uniformly deliver repellant throughout a honey super to result in near complete clearance of bees in an efficient manner. Unlike a traditional fume board, the improved fume board does not require the sun or a hot day to assist in repellant dispersal. The improved fume board utilizes an external fan-blower to increase repellant dispersal while significantly decreasing the time required for evacuation of bees from a super, which is a substantial advantage for commercial beekeepers who maintain hundreds or thousands of hives. Furthermore, unlike a breeze board, the improved fume board is not dependent upon wind for effective operation.

As discussed herein, the improved fume board 100 has a preferred embodiment which utilizes a fan-blower to disperse repellant throughout a honey super. This embodiment utilizes a detachable air-diverter device 105 that is attached directly to a fan-blower exhaust conduit 104, and thus can be removed when not in use.

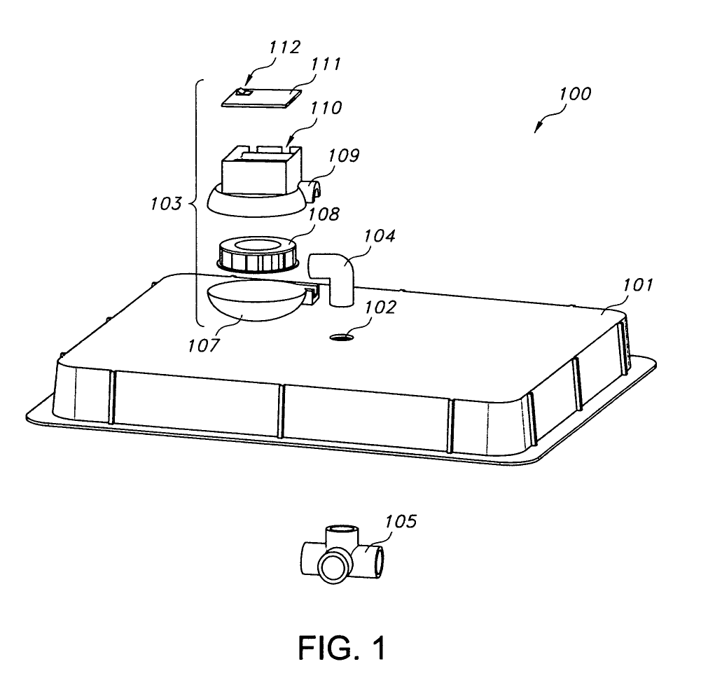

Referring to FIG. 1, which depicts an exploded top diagonal view of the preferred embodiment of the improved fume board 100 comprised of a fume board box 101, an air-intake portal 102, an electric fan-blower 103, a fan-blower exhaust elbow conduit 104, and a detachable air-diverter 105.

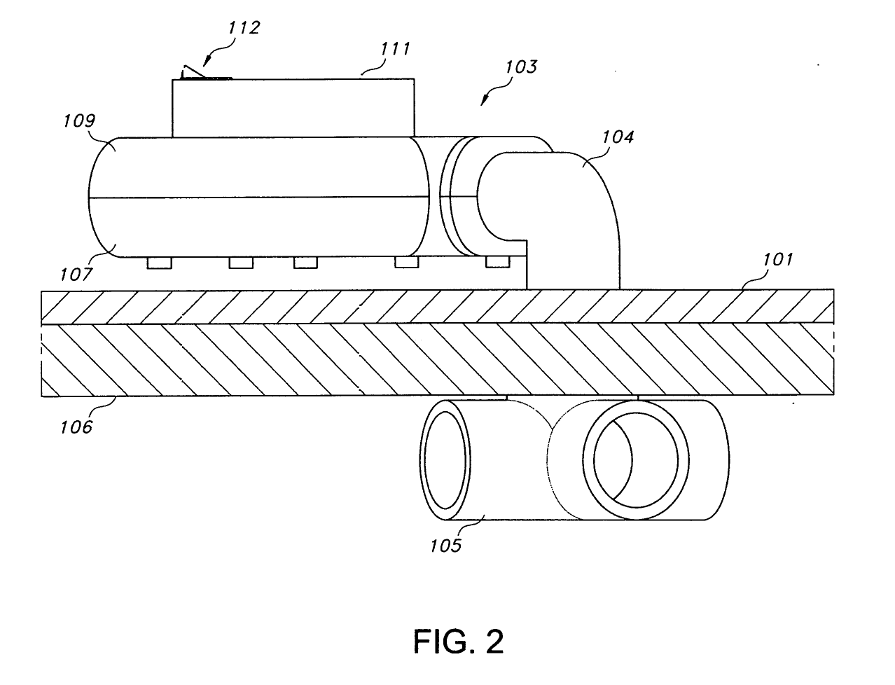

Referring to FIG. 2, which depicts an electric fan-blower 103 attached by a fan-blower exhaust elbow conduit 104 to a detachable air-diverter 105 which is positioned directly beneath the absorbent bee repellant liner 106, under the fume board box 101.

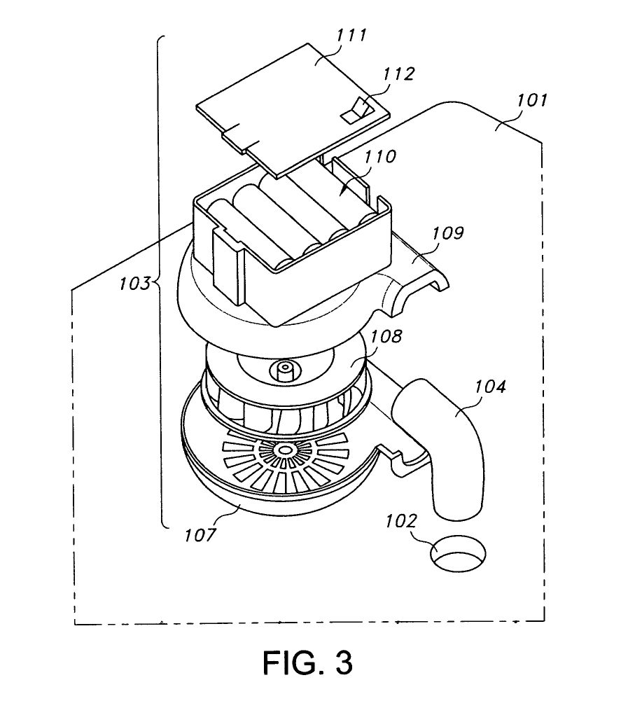

Referring to FIG. 3, which depicts an exploded view of the electric fan-blower 103, showing the lower fan-blower housing 107, internal fan blades 108, upper fan-blower housing 109, batteries 110, upper fan-blower housing top 111, fan-blower exhaust elbow conduit 104, and fume board box 101 air-intake portal 102.

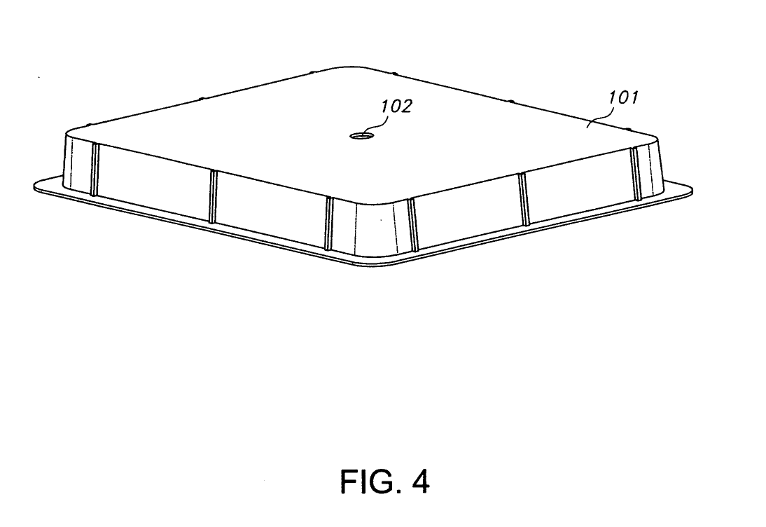

Referring to FIG. 4, which depicts a top diagonal view of the preferred shape of the fume board box 101 and air-intake portal 102.

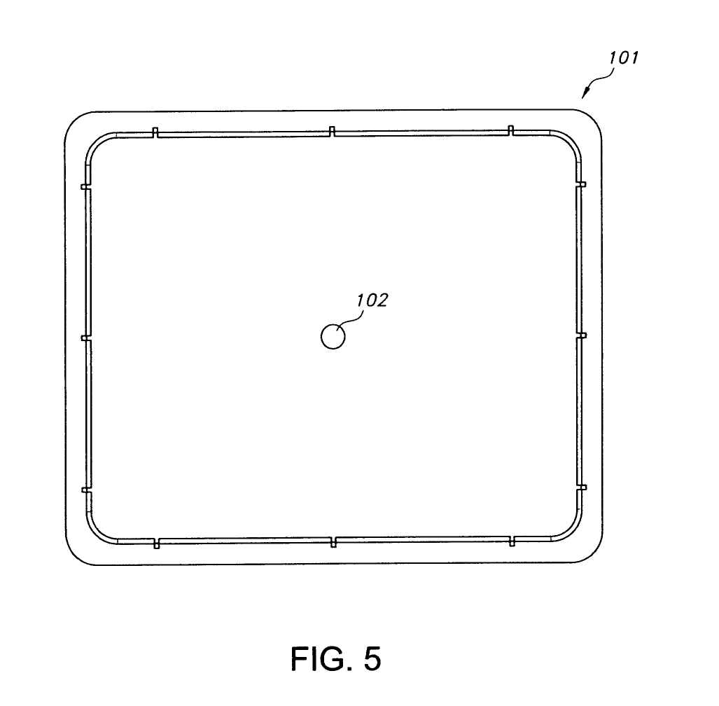

Referring to FIG. 5, which depicts a bottom view of the fume board box 101 with centered air-intake portal 102.

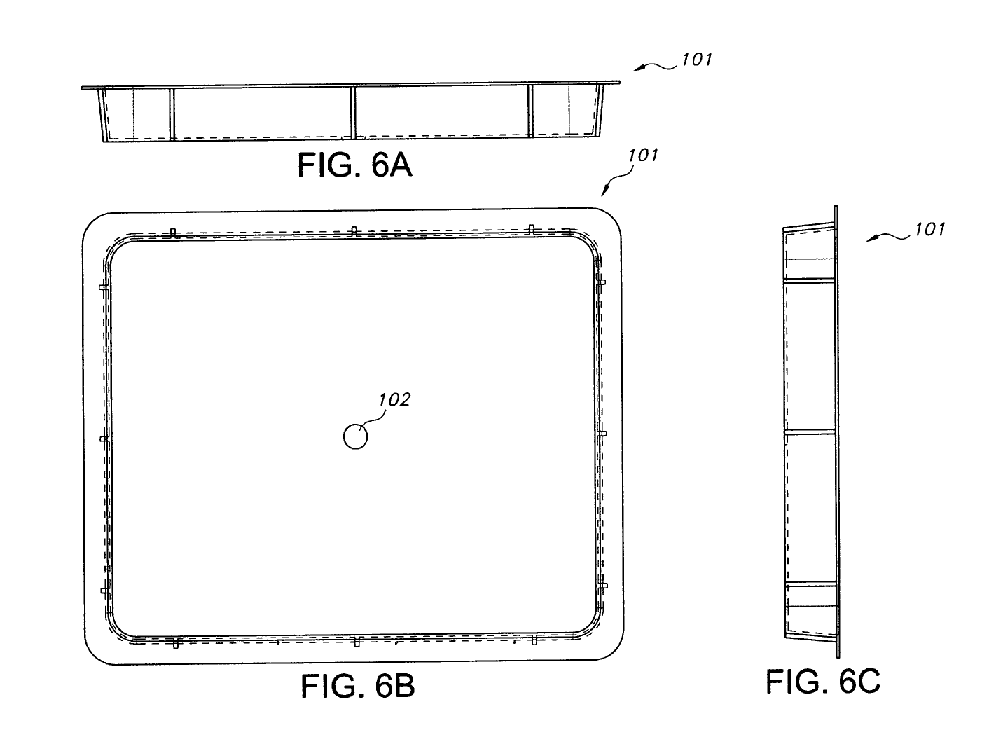

Referring to FIG. 6A, which depicts a front view of the fume board box 101; FIG. 6B, which depicts a top view of the fume board box 101 and air-intake portal 102; and FIG. 6C, which depicts a side view of the fume board box 101 with centered air-intake portal 102.

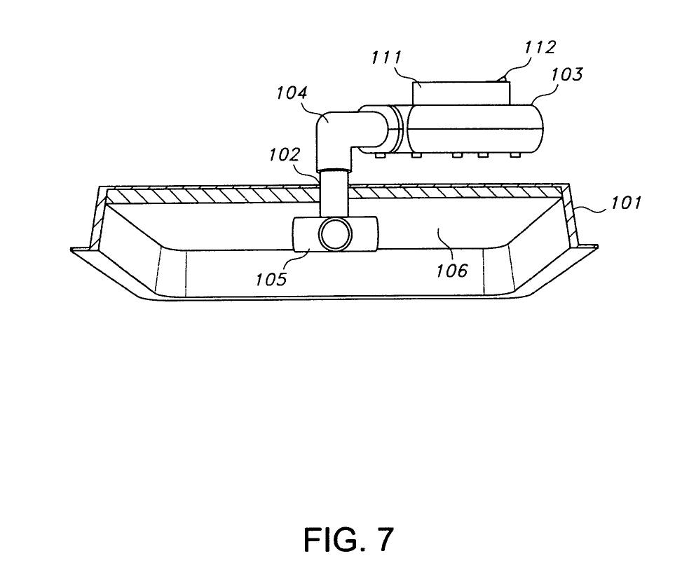

Referring to FIG. 7, which depicts a split-view of the fume board box 101, electric fan-blower 103, fan-blower exhaust elbow conduit 104, air-intake portal 102, absorbent bee repellant liner 106, and detachable air-diverter 105.

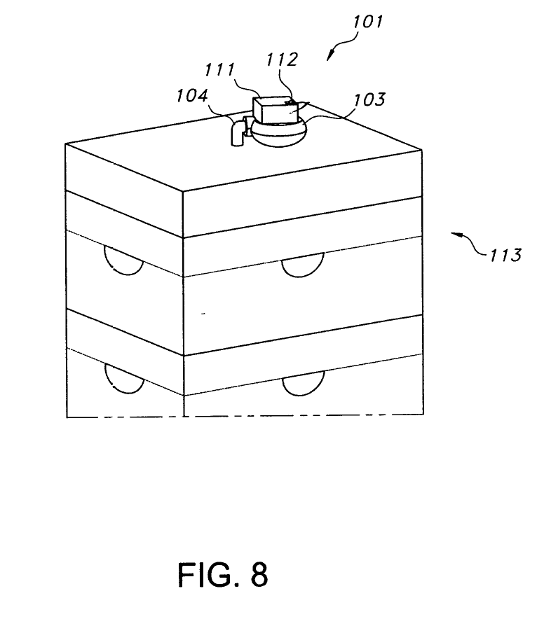

Referring to FIG. 8, which depicts the improved fume board box invention 100 positioned on a honey super 113, said depiction consisting of a fume board box 101, electric fan-blower 103, fan-blower exhaust elbow conduit 104, upper fan-blower housing 109, fan-blower housing top 111, and fan-blower switch 112.

The fume board box 101 fits on top of a hive super and has an air intake portal 102 consisting of a hole at the center or near the center of the top of the fume board box 101 which allows the fan-blower exhaust conduit 104 or other connection mechanism to connect the fan-blower 103 to the detachable air-diverter 105 inside the fume board box 101. The preferred size of the air intake portal 102 ranges in diameter from approximately 0.75 inches to 1.25 inches, depending on the related diameter of the particular fan-blower exhaust conduit 104 in use; the air intake portal 102 requires a diameter sufficient for entry of the particular fan-blower exhaust conduit 104 in use without excessive open space around the fan-blower exhaust conduit 104 that would result in the escape of air pressure during use, which in turn would diminish the efficacy of the low-pressure, air dispersal system of the improved fume board invention.

Any sturdy material or composition of such can be used to construct a fume board box 101, including but not limited to rot-resistant wood (e.g., cedar wood, cypress wood, etc.), plywood, particle board, or other composite materials. Plastic or light-weight metal may also be used to construct a fume board box 101. The fume board box 101 may be painted black or any another dark color, or covered with a suitable material that readily absorbs and radiates heat from the sun, which will increase volatilization of the repellant sprayed onto the absorbent liner 106.

In the preferred embodiment, the electric fan-blower 103 located on top of the fume board box 101 may consist of any motorized fan-blower 103 currently available on the market or the equivalent which generates steady, low-volume air-flow to accomplish an even distribution of repellant throughout the honey super 113. Many of the fan-blowers 103 currently available are battery powered, as shown in FIG. 3. Other configurations of the fan-blower 103 are contemplated and within the scope of the disclosure, including those which may be manually powered. A gentle, low-volume air-flow is evenly distributed by the improved fume board's detachable air-diverter 105 described below. A gentle, low-volume air-flow does not injure or kill bees like powerful high-volume air blowers or manual extraction methods.

The preferred fan-blower 103 is a small, motorized, battery powered fan-blower 103, which a beekeeper can turn on and off with a switch 112 during use, thus eliminating the possibility of too much intoxicating bee repellant entering a honey super 113 during bee evacuation. Because the air-diverter 105 is detachable from the fan-blower exhaust conduit 104, the fan-blower 103 can be easily removed from the improved fume board box 101, thus improving the mobility of the improved fume board in large apiaries, or during shipping or when stored, which are advantages.

As shown in FIGS. 2 and 7 of the invention's preferred embodiment, the detachable air-diverter 105 is attached directly beneath an absorbent liner 106. The absorbent liner 106 may consist of any number of materials such as soft foam, thick felt, or layered cotton fabric or burlap, to name but a few examples. The detachable air-diverter 105 has several openings which divert the air flow uniformly away from the center of the inner fume board box 101. The air blown from the fan-blower 103 through the air diverter 105 mixes with the repellant volatized from the absorbent liner 106 or other bee repellant dispersion mechanism and is gently forced down through a honey super 113.

The preferred embodiment discussed here employs a detachable air diverter 105 with four equidistant openings that evenly distribute the incoming air away from the centrally positioned air intake portal 102 and down into the fume board box 101. The detachable air-diverter 105 is easily attached to the fan-blower exhaust conduit 104 without the necessity of tools, screws, or special fittings. The invention's detachable air-diverter 105 is not limited to any one design, but includes any number of air-diverter shapes and sizes to accomplish air-dispersal in the fume board box 101 for added control of air-flow direction and volume, which is an advantage. The openings can be as few as one, as long as, air is distributed from the center of the fume board box.

Alternative embodiments of the invention may utilize an air-diverter or diverters permanently attached to the underside of the top of the improved fume board box 101, or other air-deflecting mechanisms designed to disperse incoming exhaust air from the fan-blower 103 evenly throughout the fume board box 101. Unlike the preferred embodiment discussed herein, in an alternative embodiment of the invention the fan-blower connecting mechanism does not attach directly to an air-diverter, but instead simply directs a low-volume air-flow from a fan-blower exhaust into a fume board box, where the low-volume air-flow strikes a stationary non-detachable air diverter positioned directly beneath the air intake portal. As the low-volume air-flow strikes the stationary, non-detachable air-diverter, it is deflected equilaterally throughout the fume board box where it mixes with a repellant volatized from an absorbent foam liner.

A stationary non-detachable air-diverter may be attached to the inner top of a fume board utilizing screws with screw spacers, or any other method of attachment which creates spatial separation between the intake portal and stationary air-diverter below, preferably between 0.75 and 1.00 inch to effectuate even air-flow dispersal through the fume board box. In this alternative embodiment of the invention, stationary air-diverters may be made of any suitable material like plastic or wood, and attached in any number of ways beneath an incoming low-volume air-flow.

Because one of the invention's intended purposes is to force low-volume, controlled air-flow into a fume board box where it mixes with bee repellant, which is then dispersed evenly into a honey super, the preferred embodiment described herein lends itself to various embodiments, including those which incorporate a source of repellant outside the fume board box 101, rather than utilizing a repellant-saturated pad attached beneath the top of the fume board box 101. One example of this alternative embodiment of the invention would consist of a fume board box with an external screened-top canister holding a saturated repellant filter. The canister is positioned above, and connected to the fan-blower air intake opening, so that the fan-blower pulls outside air into and through the saturated repellant filter inside the canister, then delivers the volatized repellant through a blower exhaust conduit into the fume board box where it is dispersed evenly into the honey super by a detachable or stationary air-diverter positioned beneath the air-intake portal of the fume board box. While this external repellant embodiment of the invention envisions the fan-blower and repellant canister being positioned externally on top of the fume board box, alternative embodiments may enlarge the fume board box, incorporating two compartments: an upper and a lower compartment. The upper compartment holds a fan-blower mechanism and repellant filter canister vented out the top, and the lower compartment contains the air diverter devices directly above the honey super.

The external canister and lid may be made of plastic or any other suitable material. The repellant filter may be made from any suitable filter material which will not react adversely to the chemical properties of bee repellants commonly used in traditional fume boards. The repellant filter may be manufactured without self-contained repellant properties, requiring the beekeeper to spray the repellant filter prior to use; or the repellant filter may be manufactured with a repellant-infused filter, thus eliminating the need to spray the repellant filter prior to use. The repellant filter may be manufactured from material intended for limited use duration (i.e., disposable), or long life material intended to be used for an extended length of time. The external canister and repellant filter may be designed and manufactured as separate components or as a single unit. The external canister may be designed and manufactured for long-term use, or as short-life, disposable item.

As can be seen from these descriptions of various embodiments of the invention which any person of average knowledge and skill can replicate, the abstract design and practical function of the improved fume board invention remain constant: i.e., to utilize a motorized fan-blower to deliver a controlled, low-volume air-flow of volatized repellant evenly into a honey super to effectively evacuate bees from a honey super without harming or traumatizing the bees.

In yet another alternate embodiment, various fan motors are contemplated, including, but not limited to small fan motors—electric or manually powered—to force low-volume air-flow into a fume board box, which is then disperse by an air-diverter or diverters throughout the fume board box so that the low-volume air-flow increases the speed and efficacy of dispersal of bee repellant into honey supers for bee evacuation purposes related to honey extraction.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the device described herein contain optional features that can be individually or together applied to any other embodiment shown or contemplated here to be mixed and matched with the features of that device.

While the invention has been described with respect to a single preferred embodiment, those skilled in the art, having benefit of this disclosure, will appreciate that other embodiments that can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. An improved fume board for removing bees from a honey super comprising:
a. a fume board box comprising an air intake portal;
b. a fan-blower;
c. an air diverter connected to the fan blower; and
d. a bee repellant dispersion mechanism.

2. The dispersion mechanism of claim 1 wherein said dispersion mechanism is absorbent lining.

3. The absorbent lining of claim 2 wherein said absorbent lining is foam.

4. The air diverter of claim 1 wherein said air diverter is a detachable air diverter.

5. The air diverter of claim 2 wherein said air diverter is a 4-way air diverter.

6. The air diverter of claim 2 wherein said air diverter is a 3-way air diverter.

7. The air diverter of claim 2 wherein said air diverter is a 2-way air diverter.

8. The air diverter of claim 2 wherein said air diverter is a 5-way air diverter.

9. The air diverter of claim 2 wherein said air diverter is a 6-way air diverter.

10. The air diverter of claim 2 wherein said air diverter is a stationary non-detachable device.

11. The fan-blower of claim 1 wherein said fan-blower is connected to the air diverter via a fan-blower exhaust conduit.

12. The fan-blower of claim 1 wherein said fan-blower is connected to the air diverter via tubing.

13. The fan-blower of claim 1 wherein said fan-blower is connected to the air diverter via elbow tubing.

14. The fan blower of claim 1 wherein said fan blower is motorized.

15. The fan blower of claim 1 wherein said fan blower is battery-powered.

16. The fan blower of claim 1 wherein fan blower is manually powered.

17. The air intake portal of claim 1 wherein said air intake portal is at the center of the fume board box.

18. A method for quickly and uniformly delivering repellant throughout a honey super:
a. providing a fume board comprising a fume board box, fan-blower, and air entry portal;
b. distributing air from the fan-blower through the air entry portal and air diverter;
c. mixing air from the fan blower with a repellant via a bee repellant dispersion mechanism; and
d. forcing air containing repellant through the honey super.

19. The fan blower of claim 18 wherein said ban blower is motorized.

20. The fan blower of claim 18 wherein said fan blower is battery-powered.

21. The fan blower of claim 18 wherein said fan blower is manually operated.

22. The fan blower of claim 18 wherein said fan blower has a control mechanism.

23. The fan blower of claim 18 wherein fan blower is portable.

24. The dispersion mechanism of claim 18 wherein said dispersion mechanism is an absorbent liner.

25. The fan blower of claim 18 wherein the fan blower is situated on the fume board box.

26. The fan blower of claim 18 wherein the fan blower is attachable to the fume board box.

27. The entry portal of claim 18 wherein said entry portal is at the center of the fume board box.

28. The absorbent lining of claim 24 wherein said absorbent lining is foam.

29. The absorbent lining of claim 24 wherein said absorbent lining is fabric.

30. The absorbent lining of claim 24 wherein said absorbent lining is burlap.

31. The absorbent lining of claim 24 wherein said absorbent lining is felt.
